(19) United States
(12) Patent Application Publication
(10) Pub. No.: US 2025/0053841 A1
(43) Pub. Date: Feb. 13, 2025

(54) QUANTUM BATTERY AND CHARGING AND DISCHARGING METHOD THEREOF

(71) Applicant: PLANCKIAN S.R.L., Pisa (IT)

(72) Inventors: Vittorio Giovannetti, Pisa (IT); Marco Polini, San Giuliano Terme (IT)

(73) Assignee: PLANCKIAN S.R.L., Pisa (IT)

(21) Appl. No.: 18/713,105

(22) PCT Filed: Nov. 23, 2022
(86) PCT No.: PCT/IT2022/050299

§ 371 Date: May 23, 2024

(30) Foreign Application Priority Data
Nov. 24, 2021 (IT) 102021000029696

(51) Int. Cl. G06N 10/40; H01M 14/00

(52) U.S. Cl. CPC G06N 10/40; H01M 14/00

(57) ABSTRACT

The present invention relates to a quantum battery (1) for storing and supplying energy, comprising one or more clusters (2) for storing energy, each one comprising at least one quantum cell (3), wherein each quantum cell (3) has one or more quantum energy units (31), wherein each quantum energy unit (31) is a quantum system having a plurality of energy levels (|ϵ₀)A_{j,k}, |ϵ₀)A_{j,k}, . . . , |ϵ_{d-1})A_{j,k}) to store energy. The present invention also relates to a method for charging and discharging a quantum battery (1).

The present invention relates to a quantum battery and charging and discharging method thereof.

### FIELD OF THE INVENTION

More specifically, the invention concerns a quantum battery for storing energy in an effective way, designed and realized in particular for applications that can be used for any industrial as well as domestic applications.

In the following, the description will be addressed mainly to quantum batteries to be applied to quantum computing systems, but it is clear that the same should not be considered limited to this specific use.

### PRIOR ART

As it is well known, in the last few decades, batteries have led the revolution in personal electronics and are steadily gaining an increasing importance also in the automotive sector (see [1]). Currently available batteries operate on the basis of electrochemical principles that have been developed between the Eighteenth and Nineteenth centuries (see [2]).

An ordinary electrochemical battery comprises an anode, a cathode, a liquid electrolyte, and a porous separator. Motivated by the high energy density offered by a lithium-metal anode (see [3]), several research groups and companies (see [4]) have proposed and fabricated electrochemical batteries with a solid-state separator (and a lithium-metal anode), which have been dubbed “solid-state batteries” (SSBs).

In general, finding suitable materials for fabricating the solid-state separator has proven challenging, mainly because candidate materials are required to have a high dendrite resistance.

In general, currently available batteries have several drawbacks, which are shortly discussed in the following.

A first drawback of the available batteries is that they require a remarkable amount of time for their charging process. Also, the batteries mainly used in the industry comprise liquid parts, which, beside increasing the weight, are usually toxic. This is also a problem for the disposal after the battery life, in view of the current attention to the development of green technologies.

From an operative point of view, the current batteries cannot be integrated inside quantum computing architectures. Ordinary electrochemical batteries, for example, cannot be integrated inside superconducting quantum computers, in view of the ultralow operation temperatures of the latter.

In addition, ordinary electrochemical batteries are not suitable for space technologies, mainly for reasons connected to operating temperatures. Specifically, satellites moving through interstellar space need battery packs that are heated while the satellite itself is operating in conditions of poor sun irradiation.

It is clear that currently available batteries are not suitable to be used for supplying current and future technologies.

To address the above technical limitations, quantum batteries have been recently proposed in the recent literature. Genuine quantum effects, such as phase coherence and entanglement, constitute remarkable resources, which have been shown to lead to a superior performance of technological devices of various sorts, provided that they are properly manipulated and engineered. A known example is that of a quantum computer, whereby computations are performed with the use of quantum bits (QUBITs) as compared to classical computing performed with classical bits (see [5]).

Technological research is currently focused on investigating whether genuine quantum resources can help achieving superior performances in the manipulation and processing of energy (see [6]). The term “Quantum battery” has been coined (see [7] and [8]) in such technical context of quantum thermodynamics research. In particular, it has been proposed that “entangling unitary controls”, i.e. unitary operations acting globally on the state of the N quantum cells, lead to better work extraction capabilities from a quantum battery, when compared to unitary operations acting on each quantum cell separately. In other words, it has been demonstrated (see [9]) that entanglement generation leads to a speed-up in the process of work extraction, thereby leading to larger delivered power. Then, the charging (rather than the discharging) process has been studied (see [10, 11]) and two types of charging schemes have been identified:
(i) the so-called parallel charging scheme, in which each of the N quantum cell is acted upon independently of the others; and
(ii) the collective charging scheme, where global unitary operations (i.e., the entangling unitary controls) acting on the full Hilbert space of the N quantum cells are allowed. Specifically, it has been shown that, in the collective charging case and for N≥2, the charging power of a quantum battery is larger than in the parallel scheme. This collective speed-up, stemming from the entanglement produced in the non-equilibrium dynamics accompanying the charging process of a quantum battery, has been named “quantum advantage”.

All the early pioneering studies cited above (i.e. [7-11]) contained abstract quantum-information theorems. The situation changed in 2018. Indeed, in the quest for such quantum advantage and potential laboratory implementations of quantum batteries, the abstract concepts of quantum cell and “entangling operations” were put on a concrete ground by other authors (see [12]). These researchers proposed the concept of a “Dicke quantum battery”, where an array of N qubits (i.e., the proper battery, where energy is actually stored) is coupled to a harmonic energy source (see [12-15]). Since then, many other quantum battery models have been proposed, including quantum batteries based on deterministic spin chains (see [16]), disordered spin chains (see [17, 18]), and organic compounds (see [19]).

More recently, a model quantum battery based on the so-called “SYK model” has been proposed (see [20]).

Further, another type of quantum mechanical battery has been recently proposed (see [21]). It was in particularly dubbed “Josephson phase battery”, but this quantum device does not store energy. Rather, it maintains a constant phase difference between two points in a superconducting circuit.

In addition, mathematical details pertaining to specific quantum battery models are discussed in a series of scientific publications (see [12-15,17,20]).

Based on the above, there is not yet available a satisfactory quantum battery in the market, capable of the performances required by the applications to the industry sector and, in general, by practical applications.

### SCOPE OF THE INVENTION

In light of the above, scope of the present invention is that of proposing a battery capable of overcoming the drawbacks of the ordinary available batteries as well as the currently available quantum batteries.

Another purpose of the invention is to propose fast charging batteries.

An additional proposal of the present invention is to propose a quantum battery that can operate in an ultra-wide temperature range.

### OBJECT OF THE INVENTION

It is, therefore, object of the present invention a quantum battery for storing and supplying energy, comprising one or more clusters for storing energy, each one comprising at least one quantum cell, wherein each quantum cell has one or more quantum energy units, wherein each quantum energy unit is a quantum system having a plurality of energy levels to store energy.

Always according to the invention, said quantum energy unit may be a QUBIT as two-energy level quantum system, or a QUTRITs as three-energy level quantum system, or a QUDIT as a quantum system with a discrete number of energy levels.

Further according to the invention, each one of said quantum cells may comprise a plurality of quantum energy units, and an inner quantum bus, operable for causing mutual interactions between said quantum energy units inside each quantum cell, wherein said inner quantum bus is a quantum mechanical system, and wherein each quantum energy unit couples with said inner quantum bus of the corresponding quantum cell, under resonant conditions.

Still according to the invention, each quantum cell may comprise a first control line, which is adjustable by an external control, for adjusting the charging process of each quantum cell.

Advantageously according to the invention, said inner quantum bus have a discrete energy spectrum comprising a finite collection of frequencies {ω_{B}}, wherein said finite collection of frequencies {ω_{B}} can be modified by said first control lines.

Always according to the invention, the resonant condition may occur when said first control line allows that one of frequencies {ω_{B}} of the discrete energy spectrum of said inner quantum bus is in resonance with one of the level-spacings of the energy spectrum of one of the quantum energy units, so as to allow for an energy exchange among the inner quantum bus and the corresponding quantum energy units within a relevant quantum cell, and the energy flow from said quantum battery is inhibited by setting the frequencies {ω_{B}} off-resonant with respect to the energy spectrum of the quantum energy units.

Still according to the invention, said quantum battery may comprise a plurality of clusters, and one or more outer quantum bus, wherein each outer quantum bus is connected to at least one of said clusters, to couple the quantum cells of said clusters, wherein each outer quantum bus is connectable to at least one external power sources, for charging the quantum energy units, and/or to at least one load, to be supplied by the energy stored in said quantum energy units, and wherein said outer quantum bus is operable to charge and discharge the quantum energy units of the quantum cells contained in said clusters.

Further according to the invention, each outer quantum bus may be connectable to said at least one external power sources and/or to said at least one load through electrodes.

Advantageously according to the invention, said outer quantum bus may have a continuous energy spectrum.

Always according to the invention, said outer quantum bus may be a waveguide, wherein the propagating electromagnetic modes of the waveguide connects said quantum cells. Advantageously according to the invention, the quantum battery may comprise second control line to control said outer quantum bus, implemented with voltage/magnetic pulses, for tuning the interactions between said outer quantum bus and said inner quantum bus.

Still according to the invention, said quantum energy unit may be a quantum dot, and said quantum cell may be an electromagnetic cavity.

Further according to the invention, said electromagnetic cavity may be a Fabry-Pérot resonator, the inner quantum bus may be operated by the modes of the quantized cavity electromagnetic field, and the outer quantum bus may be operated by the electromagnetic modes propagating in wave guides, which connect together the quantum cells.

Advantageously according to the invention, each cluster may comprise a plurality of quantum cells, and

each cell may comprise a plurality of quantum energy units.

Preferably according to the invention, said clusters may be arranged in a network selected among the following: a linear network; a snake-like network; or in a three-dimensional network, as a stack of two-dimensional interconnected quantum cells.

Always according to the invention, said cluster may have a planar square geometry.

Still according to the invention, each of said quantum energy units may be a fully tunable artificial metallic macro-atoms, each one having a ground state and at least excited state, each one of said quantum cell may be built by a discrete set of fully tunable artificial metallic macro-atoms, and said inner quantum bus may comprise an electromagnetic cavity or resonator, where each of said quantum cells is contained, wherein a quantized microwave radiation field is contained in said electromagnetic cavity or resonator.

Further according to the invention, said quantum energy unit may be a transmon-type superconducting QUBITs embedded in a coplanar waveguide resonator.

Preferably according to the invention, the transmon may be made of aluminum and/or Yttrium barium copper oxide—YBCO.

Advantageously according to the invention, said artificial atoms may be made of semiconducting materials, wherein said semiconducting materials are selected among the following: silicon quantum dots; gallium arsenide quantum dots; cadmium selenide (CdSe) quantum dots; and carbon nanotube quantum dots.

Still according to the invention, said semiconducting quantum dots may host both charge and spin.

It is also specific object of the present invention a method for charging and discharging a quantum battery, wherein said quantum battery comprises: one or more clusters, each one comprising at least one quantum cell, wherein each quantum cell has one or more quantum energy units having a plurality of energy levels to store energy; a first control line; and an inner quantum bus, which couples with said inner quantum bus of the corresponding quantum cell, under resonant conditions said inner quantum bus, wherein said inner quantum bus has a discrete energy spectrum comprising a finite collection of frequencies, wherein said finite collection of frequencies can be modified by said first control lines; wherein the battery charging comprises the steps of applying a resonant excitation between the inner quantum bus and the quantum energy units of the quantum cells by said first control line such that one of frequencies {ω_{B}} of the discrete energy spectrum of an inner quantum bus is in resonance with one of the level-spacings of the energy spectrum of an individual quantum energy units, to allow an energy exchange.

Always according to the invention, said method may comprise the step of using said second control line to connect at least two clusters of quantum energy units via an outer quantum bus, to allow for energy exchange between the said clusters, wherein said at least one an outer quantum bus is connectable to at least one external power sources, for charging the quantum energy units, and/or to at least one load, to be supplied by the energy stored in said quantum energy units.

Further according to the invention, said method may comprise the step of setting the frequencies {ω_{B}} off-resonant with respect to the energy spectrum of the quantum energy units, so as to inhibit the energy flow.

### BRIEF DESCRIPTION OF THE FIGURES

The present invention will be now described, for illustrative but not limitative purposes, according to its preferred embodiments, with particular reference to the figures of the enclosed drawings, wherein:

FIG. 1 illustrates a schematic of a first embodiment of a quantum battery according to the present invention;

FIG. 2 illustrates a quantum cell of the quantum battery of FIG. 1;

FIG. 3 illustrates a second embodiment of the quantum battery according to the present invention;

FIG. 4 illustrates a third embodiment of the quantum battery according to the present invention;

FIG. 5 illustrates a fourth embodiment of the quantum battery according to the present invention;

FIG. 6 illustrates a fifth embodiment of the quantum battery according to the present invention; and

FIG. 7 illustrates a sixth embodiment of the quantum battery according to the present invention.

### DETAILED DESCRIPTION

In the various figures, similar parts will be indicated by the same reference numbers.

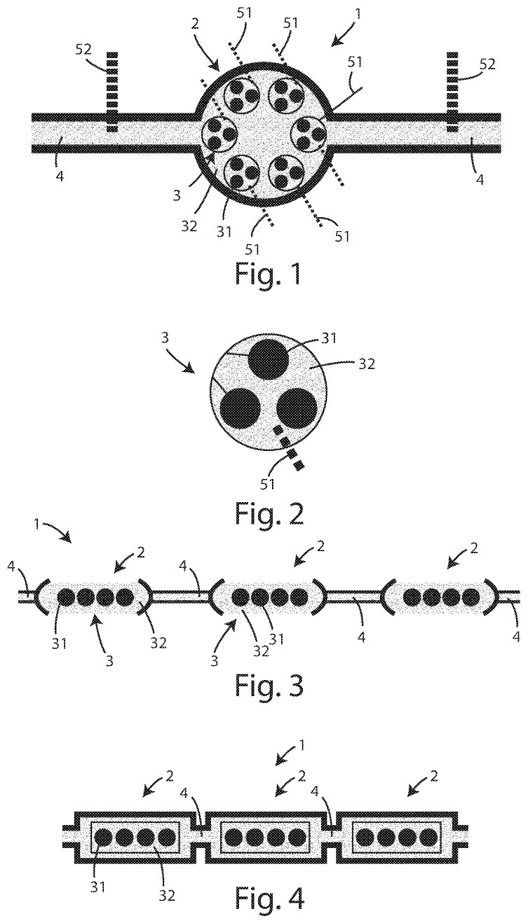

Referring to FIGS. 1 and 2, a first embodiment of a quantum battery 1 according to the present invention is shown.

The quantum battery 1 comprises one cluster 2 of quantum cells 3, wherein each quantum cell 3 is interconnected with each other, as better specified below.

In some embodiments, the clusters 1 can be more than one and arranged in a two-dimensional or a three-dimensional network, as better explained and discussed below.

Each quantum cell 3 comprises a plurality of more fundamental quantum energy units 31. Each quantum energy unit 31 can be a quantum bit or QUBIT, namely a 2-energy level quantum system, a quantum trit or QUTRIT, namely a 3-energy level quantum system, or, in general, a quantum dit or QUDIT, namely a d-energy level quantum system.

In the embodiment shown, each quantum cell 3 comprises three quantum energy units 31. In other embodiments, a different number of quantum energy units 31 can be implemented.

In a general quantum battery 1, there is a collection of N_{CELL} quantum cells 3, and each quantum cell 3 comprises a collection of N quantum energy units 31.

In FIG. 1, where the first embodiment of the quantum battery 1 is illustrated, N_{CELL}=6 and N=3. In general, these two quantities can take any integer value larger than or equal to 1. The quantum energy units 31 are nominally identical quantum mechanical, non-interacting systems, each characterized by internal degrees of freedom, which, in the absence of mutual interactions, allow them to store energy in an ordered sequence of (say) d≥2 discrete levels ε_{d-1}≥ . . . ≥ε₁≥ε₀=0, with ε₀=0 representing the ground level of the quantum energy unit 31 and ε_{d-1} the corresponding maximum energy value.

For d=2, the quantum energy units 31 can hence be identified with 2-energy level quantum systems, i.e. QUBITs; for d=3 with QUTRITs; while for generic (integer) d the quantum energy unit coincides with a QUDIT.

In a real implementation, the quantum energy units 31 do not need to be identical but there can be differences. For example, the energy spacing between two consecutive levels might not be the same for all quantum energy units 31. These “inhomogeneities” do not affect the fast-charging properties of the quantum battery 1 according to the invention.

Each quantum cell 3 comprises an inner quantum bus 32, which connects the quantum energy units 31 contained in a quantum cell 3 with each other.

The inner quantum bus 32 is also a quantum mechanical system that mediates the effective mutual interactions between all the quantum energy units 31 inside a given quantum cell 3. With the term “mediate” it is meant the fact that the inner quantum bus 32, through an external electric or magnetic field, allows the energy transmission among the quantum energy units 31 hence inducing mutual interactions between them. These interactions are responsible for ultrafast charging of a single quantum cell 3.

Also, each quantum cell 3 comprises a first control line 51, particularly a classical control line, based for example on a voltage/magnetic field control, which can be externally adjusted, for tuning, as better explained below, the charging process of each quantum cell 3.

The quantum battery 1 comprises also an outer quantum bus 4, which is a secondary quantum medium. The outer quantum bus 4 allows the interaction of the different quantum cells 3.

Depending on the specific implementation, the outer quantum bus 4 may or may not coincide with the inner quantum bus 32. The outer quantum bus 4 plays two roles. On one hand, via the action of a dedicated second classical control line 52 which also in this case can be implemented with voltage/magnetic pulses, the outer quantum bus 4 is the medium that enables the coupling between the various quantum cells 31. On the other hand, the outer quantum bus 4 operates as a charging and discharging channel for the quantum battery 1, allowing the energy to be moved-in and/or moved-out from the battery system. This is therefore akin to the role played by an electrical source (i.e., the electrical current) for an ordinary electrochemical battery, when the battery is coupled to a power source or load.

Each quantum battery 1 is also characterized by the quantum degrees of freedom of the medium that surrounds the quantum energy unit 31 inside a given quantum cell 3, namely said inner quantum bus 32, and by the medium that instead couples the various quantum cells 3 inside the quantum battery 1, namely said outer quantum bus 4.

The main difference between the inner quantum bus 32 and the outer quantum bus 4 is associated with their spectral properties. More specifically, while the outer quantum bus 4 can have a continuous energy spectrum, the inner quantum bus 32 is assumed to have a discrete energy spectrum identified by a finite collection of frequencies {ω_{B}}, which can be modified by the first control line 51. For instance, in a practical implementation of a quantum battery 1, better disclosed below, the inner quantum bus 32 can be identified with modes of the quantized electromagnetic field associated with a high-quality resonator (or a cavity) that hosts the associated quantum energy units 31. Similarly, the outer quantum bus 4 can be associated with the propagating electromagnetic modes of a wave guide, which connects the various quantum cells 3 of the quantum battery 1, as can be better seen in FIG. 2.

The role of the inner quantum bus 32 is that of acting as a mediator for the interactions between the various quantum energy units 31 that compose a given quantum cell 3, as well as to allow for energy transfer from and to the quantum energy units 31. This is made possible due to the presence of an interaction Hamiltonian that couples each quantum energy unit 31 with the inner quantum bus of the corresponding quantum cell 3, under resonant conditions.

Resonant condition occurs when the first control line 51 in FIG. 1 is such that one of frequencies {ω_{B}} of the discrete energy spectrum of the inner quantum bus 32 is in resonance with, i.e. equal to, one of the level-spacings of the energy spectrum of the individual quantum energy units 31.

Such interactions allow for an effective energy exchange among the inner quantum bus 32 and the corresponding quantum energy units 31 within a quantum cell 3. On the contrary, by setting the frequencies {ω_{B}} in such a way to be off-resonant with respect to the energy spectrum of the quantum energy units 31, energy flow is inhibited, resulting in an effective energetic isolation of the quantum energy units 31 from the surrounding medium, leaving aside intrinsic losses which can be minimized in a variety of ways, depending on the actual implementation.

The function of the outer quantum bus 4, instead, is that of acting as a mediator for the interactions among the various quantum cells 3, and also as a connector between the quantum battery 1 and the external environment or systems, e.g., power sources and loads. In this case, this is made possible due to the presence of “exchange” (beam-splitter like) interactions between the outer quantum bus 4 and the inner quantum bus 32, which allow for energy flow among them and are externally tunable via the dedicated second control lines 52, which, as mentioned is a classical control line.

Finally, said outer quantum bus 4 allows varying the geometry of the quantum battery 1 by allowing alternative topological configurations, according to the necessities, which originate from how various quantum cells 3 are arranged in real space.

Similarly, to what happens in conventional quantum computing architectures, classical control lines, such as the first 51 and the second 52 control lines in scheme described above are responsible for the generation of electrical and magnetic signals that bias the dynamical evolution of the quantum hardware of the setup.

While the specific nature and form of such controls strongly depend on the implementations under consideration, at the fundamental level they typically leveraged on the Zeeman effect, the Stark effect, and on the Coulomb repulsion effect. It is recalled that the first two of such effects are associated with the possibility of influencing energy spectral lines of a quantum system through the action of external magnetic or electric fields respectively. The above control techniques are routinely applied in Nuclear Magnetic Resonances [59], in ion traps [60, 61], in N-V centers in diamond [62], as well as in superconducting qubits implementations [63, 64, 65].

External electric fields can also be used to induce control on the system by tuning the reflectivity and the transmissibility of waves guides that act as quantum buses 4 among the various quantum energy units of the setup [see 78, 79].

Coulomb repulsion is instead often employed in low-dimensional semiconductor devices (e.g., a GaAs/(Al,Ga)As heterojunction, a Si/SiGe heterojunction, or a Si-metal-oxide semiconductor (MOS) structure [66, 67]) as a method to tune quantum tunnel or to activate/disactivate electron-electron coupling among adjacent quantum dots via the action of external potential gates that are superimposed on the devices.

The operation of the quantum battery 1 described above is as follows.

To better describe the operation of the quantum battery 1, the charging and discharging processes are disclosed. In particular, it is adopted the conventional Dirac notation (see [22]), indicating with |ϵ₀ [symbol] _{A}_{_{j,k}}, |ϵ₁ [symbol] _{A}_{_{j,k}}, . . . , |ϵ_{d-1} [symbol] _{A}_{_{j,k}} the energy eigenstates associated with energy levels of the of the j-th quantum energy unit 31 of the k-th quantum cell 3. It is denoted by

$${H}_{{A}_{j , k}} = {Σ}_{l = 0}^{d - 1} {ϵ}_{l} \vert {ϵ}_{l} {〉}_{{A}_{j , k}} 〈 {ϵ}_{l} \vert \qquad ( 1 )$$

the associated Hamiltonian operator, which defines its energy spectrum. When all the quantum energy units 31 of the k-th quantum cell 3 are in the ground state, the joint state of such quantum cell 3 is described by the quantum mechanical vector (in the Hilbert state)

$$\vert {Ψ}_{0} {〉}_{{A}_{k}} = \vert {ϵ}_{0} {〉}_{{A}_{1 , k}} ⊗ \vert {ϵ}_{0} {〉}_{{A}_{2 , k}} ⊗ … ⊗ \vert {ϵ}_{0} {〉}_{{A}_{N , k}} \qquad ( 2 )$$

which represents the special configuration where no energy is stored in the device. Any other configuration |Ψ [symbol] _{A}_{ₖ} different from |Ψ₀ [symbol] _{A}_{ₖ} corresponds to the case where the k-th quantum cell 3 of the quantum battery 1 is instead charged or partially charged.

The average amount of energy stored in the k-th quantum cell 3 is provided by the quantum mechanical expectation value

$${E}_{k} ( Ψ ) {=}_{{A}_{k}} 〈 Ψ \vert {H}_{{A}_{k}} \vert Ψ {〉}_{{A}_{k}} \qquad ( 3 )$$

$$With$$

$${H}_{{A}_{k}} = {Σ}_{j = 1}^{N} {H}_{{A}_{j , k}} \qquad ( 4 )$$

being the total Hamiltonian of the k-th quantum cell 3. Accordingly, an process that in a time interval T, leads to a transition from |Ψ₀ [symbol] _{A}_{ₖ} to a state |Ψ [symbol] _{A}_{ₖ}≠|Ψ₀ [symbol] _{A}_{ₖ} represents a charging operation for the quantum battery 1. Thus in such time interval T, an amount Eₖ(Ψ) of energy is loaded into the device, namely into the quantum battery 1.

Similarly, any reverse procedure where the quantum battery 1 “moves” from |Ψ [symbol] _{A}_{ₖ} towards |Ψ₀ [symbol] _{A}_{ₖ} in a time interval T′, represents a discharging operation of duration T′, during which the quantum battery 1 has released an energy Eₖ(Ψ).

As mentioned above, the energy flows from and into the quantum energy units 31 of a given quantum cell 3 due to said inner 32 and outer 4 quantum buses.

More in detail, the charging process of a quantum battery 1 formed by N_{CELL} quantum cells 3 is disclosed, each containing N quantum energy units 31. It is assumed that, initially, the quantum battery 1 contains no energy, neither in the quantum energy units 31, nor in the surrounding media, namely the inner quantum bus 32 and the outer quantum bus 4. Accordingly, the joint state of the whole system (quantum cells 3, quantum cells 3 and the inner quantum bus 32 and the outer quantum bus 4) is described as

$$\vert {Ψ}_{0} {〉}_{{A}_{1}} ⊗ \vert {Ψ}_{0} {〉}_{{A}_{2}} ⊗ … ⊗ \vert {Ψ}_{0} {〉}_{{A}_{{N}_{CELL}}} ⊗ \vert 0 {〉}_{Inner QUBUS} ⊗ \vert 0 {〉}_{Outer QUBUS} \qquad ( 5 )$$

with |0 [symbol] _{QUBUS-I} and |0 [symbol] _{QUBUS-II} representing the vacuum energy states of the inner quantum bus 32 and outer quantum bus 4, respectively.

In order to charge the quantum system, namely the quantum battery 1, a certain amount of energy (for example, in the form of electromagnetic energy) is loaded into the outer quantum bus 4 by an external power source, whose net effect is to move it away from |0 [symbol] _{Outer QUBUS}.

By means of the second classical control lines 52, the energy transfer from the outer quantum bus 4 into the individual media inner quantum bus 32 is allowed, by forcing resonant conditions between the latter and the quantum energy units 31 via the first classical control lines 51. This causes the transferring of excitations from inner quantum bus 32 to the quantum energy units 31 while at the same time inducing an effective interaction between the individual quantum energy units 31 that speeds-up, in a collective fashion, the whole process.

This collective speed-up, which is partly due to the many-body nature of the problem (i.e., due to the fact that all quantum energy units 31 interact via effective interactions mediated by the quantum buses) and partly due to entanglement generation during the non-equilibrium dynamics, is what makes our quantum batteries 1 more performing with respect to ordinary electrochemical batteries.

As verified in a series of theoretical and numerical calculations, quantum batteries 1 according to the invention display indeed a collective speed-up manifesting with a dramatically reduced charging time, which actually decreases with a power law as the total number of interacting quantum energy units 31 (upper bounded by the product N_{CELL}N) increases.

Referring to FIGS. 3-7, different possible topologies of the quantum battery 1 according to the invention are illustrated.

In particular, FIG. 3 illustrates a second embodiment of the quantum battery according to the invention, which is a schematic representation of a quantum battery 1 composed by N_{CELL}=3 quantum cells 3, each containing N=4 quantum energy units 31, implemented e.g. with quantum dots (black circles) hosted inside a high-quality electromagnetic cavity (such as a Fabry-Pérot resonator), acting as quantum energy unit 31.

In this embodiment, the modes of the quantized cavity electromagnetic field play the role of the inner quantum bus 32. The outer quantum bus 4 instead is represented by electromagnetic modes propagating in wave guides, which connect together the various quantum cells (i.e. cavities). In the FIG. 3 the first 51 and the second 52 classical control lines are not shown.

FIGS. 4, 5, 6, and 7 show a third, a fourth, a fifth and a sixth embodiment of the quantum battery 1 according to the invention, in one and two spatial dimensions.

More specifically, FIG. 4 shows a linear (one-dimensional) quantum battery 1 formed by N_{CELL}=3 quantum cells 3, each containing N=4 quantum energy units 31, arranged in a linear network.

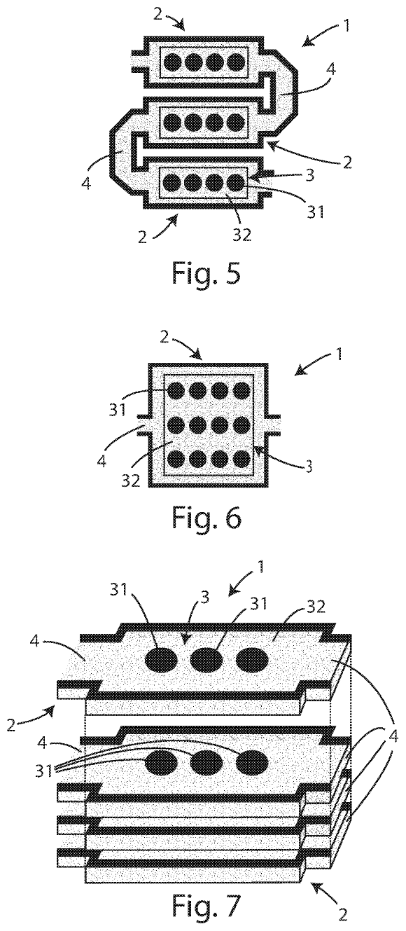

FIG. 5 shows a snake-like quantum battery 1 realized with N_{CELL}=3 quantum cells 31, each containing N=4 quantum energy units, arranged, as said, in a snake-like geometry.

FIG. 6 shows a planar (two-dimensional) quantum battery 1 realized with a single (N_{CELL}=1) quantum cell 3 containing N=12 quantum energy units 31 arranged in a planar square geometry. In other embodiments, other planar geometries can be envisioned.

FIG. 7 shows an embodiment of a three-dimensional quantum battery 1. The three-dimensional quantum battery 1 formed by a stack of two-dimensional interconnected quantum cells 3 (containing a generic number N_{CELL} of quantum cells 3), each containing N=3 quantum energy units 31. In the figure the first 51 and the second 52 classical control lines are not shown.

### Practical Implementations: Types of Qubits, Quantum Buses, and Materials

Three possible implementations of quantum batteries 1 are disclosed, or specifically, in a first embodiment it is disclosed a quantum battery based on metallic materials,—one based on semiconducting materials, and one based on semi-metallic materials.

As stated above, the quantum batteries 1 can however be built with any of the quantum technology platforms that are being currently studied and implemented, including those ones that are not based on solid state materials.

In addition, as mentioned above, the quantum batteries 1 according to the present invention can be build based on the architecture above, using neutral atoms and their Rydberg states, trapped ions, etc.

### Metallic QUCELLs

As mentioned above, the quantum batteries 1 according to the invention are clusters 2 of quantum cells 3 and each quantum cell is a collection of fundamental quantum energy units 31.

In the following, only quantum energy units 31 as a QUBIT are considered. Also, in this section a metallic quantum battery 1 is considered, wherein the inner quantum bus 32 coincides with outer quantum bus 4. For the sake of simplicity, we will therefore refer to a single quantum bus, which will be referred to as quantum bus.

A quantum cell 3 can be built by considering a discrete set of fully tunable artificial (two-level) metallic macro-atoms with a ground state |g [symbol] and an excited state |e [symbol] , placed at fixed positions in space, inside a high-quality electromagnetic cavity (namely a cavity with reduced photon losses), usually called a “high-Q resonator”, containing a quantized microwave radiation field.

In this case, and with reference to the general architecture described above, the artificial macro-atoms play the role of the QUBITs, while the quantized microwave radiation field plays the role of the quantum bus. Specifically, it is considered N transmon-type (see [23, 24]) superconducting QUBITs embedded in a coplanar waveguide resonator (such as the one described in FIG. 1 of [25]).

This kind of QUBITs can be manufactured with electron beam lithography and standard evaporation techniques (see, for example, [25] for the case of Al/AlOₓ/Al).

The material used to fabricate a transmon is typically aluminum. Recent progress in fabrication techniques has led to the possibility to use granular aluminum (see [26, 27]) and Yttrium barium copper oxide—YBCO (see [28, 29]) to build superconducting qubits. In some embodiments the transmission can be fabricated with standard aluminum to jump start the fabrication of prototypes, but YBCO qubits can be realized, so as to build metallic batteries operating at higher temperatures than the critical temperature of superconducting aluminum.

In other words, it is noted that YBCO and other high-temperature superconducting materials offer unprecedented opportunities to fabricated transmon-based quantum batteries 1 operating at temperatures that are much higher than the critical temperature of superconducting aluminum.

For the transmon-type implementation of the quantum battery 1 we are discussing here, the classical control realized by the first 51 and/or the second 52 control lines corresponds to the possibility of tuning the frequency of the qubit elements by modifying either their Coulomb energy or their Josephson energy via properly selected voltage or flux biases (see e.g., [68]). The main purpose of such operations is to activate/de-activate resonance effects between the quantum battery elements and the transmission line cavity where they are embedded. Such effects can be formally achieved e.g., by using external microwave pulses [69], parametrically modulated couplers [70, 71], parametrically modulated qubits [73], gates implemented with tuneable-frequency qubit-qubit resonances [74, 75, 76] and gates implemented with tuneable couplings [77].

Let L be the length of the resonator, which is usually taken to be on the order of 4-5 cm. An elementary quantum cell 3 of a metallic quantum battery 1 with such L can contain up to N=6 QUBITs. Let ωᵣ be the angular frequency of the main mode of the resonator, so that vᵣ≡ℏωᵣ/(2π) is the frequency of the mode (typically in the range 5-7 GHz for a microwave resonator). Let ℏω_{i,ge} be the energy separation between ground and excited state of the i-th qubit, i being a discrete index running from i=1 to i=N. When ω_{i,ge}=ωᵣ each QUBIT is resonantly coupled to the inner quantum bus 32. When this resonant condition is satisfied, energy can flow from the microwave radiation field to the array of QUBITs, and the quantum cell 3 can be charged. When ω_{i,ge}≠ωᵣ, each QUBIT of the elementary quantum cell 3 is said to be off resonance with respect to the inner quantum bus 32. In this case, the QUBITs and the quantum bus are decoupled. The condition ω_{i,ge}=ωᵣ or ω_{i,ge}≠ωᵣ can be achieved via the application of a tiny external classical magnetic field, which plays the role of the classical control line mentioned above. By using typical physical parameters of aluminum-based transmons (see, e.g., [25]), the charging time t₆ of a quantum cell of 4-5 cm hosting N=6 aluminum transmon QUBITs is on the order of t₆≅5 ns.

### Semiconducting Quantum Cells

Artificial atoms can also be constructed by employing semiconducting rather than metallic materials. Several years of research have led to remarkable advances in nanofabrication techniques, which, in turn, have led to the possibility of building a variety of semiconductor-based “quantum dots”.

Examples of such technologies include silicon quantum dots (see [30-33]), gallium arsenide quantum dots (see [34,35]), cadmium selenide (CdSe) quantum dots (see [36]), and carbon nanotube quantum dots (see [37,38]). Some of these, like silicon and carbon nanotube quantum dots, are biocompatible and may therefore play a pivotal role in the development of green quantum battery technologies. Semiconducting quantum dots can host both charge and spin QUBITs and they are a promising platform for the realization of a quantum computer.

Typical level spacings (i.e., energy difference between ground and main excited state) of semiconducting quantum dots tend to be higher than their metallic, transmon-type, counterparts.

For example, colloidal quantum dots such as core-shell CdSe dots (see [36]) have typical level spacings of hundreds of Terahertz (THz) (3 THz correspond to ˜12.4 meV). Quantum dots with these level spacings and quantum dots with even larger spacings have three main advantages for the quantum battery 1 technology:
They lead to quantum batteries 1 that can operate at much larger temperatures than transmon-based quantum batteries. A quantum battery based on QUBITs that work properly as two-level systems needs to operate at a temperature T such that k_{B}T<ℏω_{i,ge}, where k_{B}˜1.38×10⁻²³ J/K is Boltzmann constant and ω_{i,ge} has been defined above. By working with QUBITs with larger values of ℏω_{i,ge}, the operation temperature therefore increases.
They can be coupled to an electromagnetic QUBUS with much shorter wavelength, leading to ultra-compact quantum cells 3, much smaller than the coplanar microwave resonator discussed above in the context of metallic batteries.
They lead to quantum batteries 1 with increased energy density, as compared to the transmon-based QUBAs introduced above and therefore pave the way for a wealth of applications transcending quantum computing.

As far as typical quantum buses for semiconducting quantum batteries 1 are concerned, we note that semiconductor quantum dots have been coupled to the modes of a quantized electromagnetic field. For example, semiconducting quantum dots have already been successfully coupled to microwave resonators (see [34, 35, 37, 38]) and photonic crystals (see [39-42]). Finally, recent experimental progress in the field of two-dimensional electron systems hosted by semiconductor heterostructures (see [43-49]) may lead to the possibility of coupling a wide array of electrostatically-defined semiconducting quantum dots to THz planar microcavities.

### Semi-Metallic Quantum Cells

There are quantum batteries 1 where entanglement during the charging dynamics generates a collective advantage of certified quantum-mechanical origin (see [20]). The quantum battery model that was used in the numerical simulations reported in [20] was based on all-to-all inter-QUBIT interactions of the type proposed by Sachdev, Ye, and Kitaev (SYK) (see [50-53]) in the context of strongly correlated models and non-Fermi-liquid states of quantum matter. SYK-type interactions have not yet been demonstrated in a laboratory. There are several proposals though to engineer SYK interactions in a condensed matter setup (see [54]).

The SYK model describes a system of fermions in a zero-dimensional system, subject to random all-to-all four-fermion interactions. The authors of Ref. [55] have therefore proposed to realize the SYK model in a graphene quantum dot with irregular boundaries and subject to a strong applied magnetic field. Graphene quantum dots cannot be realized electrostatically but only by etching (because of the so-called Klein tunneling [56]). Disordered boundaries naturally occur in the nanofabrication procedure that leads to the quantum dot. The strong applied magnetic field limits, however, the actual potential of the set up proposed in Ref. [55] for any realistic technology. Another possibility would be to use a pseudo-magnetic field instead of a real one. This, however, remains to be studied theoretically. We emphasize that SYK QUBAs could be realized by creating e.g. a planar array of interconnected graphene quantum dots.—In this case, the electromagnetic quantum buses discussed above in the other implementations would not be needed since long-range electron-electron interactions alone would be responsible for inter-dot SYK-type interactions.

Other solid-state proposals to realize the SYK model have been made, but they are all based on so-called Majorana fermions [57,58]. Such elusive quasiparticles can be realized in solid-state platforms containing superconductors. In this patent we will not elaborate further on quantum batteries 1 based on Majorana fermions.

### Advantages

It is an advantage of the quantum battery according to the present invention that it can be charged in a very fast way, if compared with currently available batteries in the market. In particular, metallic batteries according to the present invention charge in a time scale on the order of a few nanoseconds.

Another advantage of the quantum battery according to the present invention is that it does not contain liquid parts and it is therefore a solid-state battery.

It is an additional advantage of the quantum battery according to the present invention the fact that they do not contain toxic elements. They can be built on the basis of a variety of non-toxic materials such as aluminum and graphene, or standard non-toxic semiconductors used in portable electronics such as silicon.

It is also an advantage of the quantum battery according to the present invention that it is compatible with quantum computing technologies.

It is an additional advantage of the quantum battery according to the present invention that it does not need any heating system.

The present invention has been described for illustrative but not limitative purposes, according to its preferred embodiments, but it is to be understood that modifications and/or changes can be introduced by those skilled in the art without departing from the relevant scope as defined in the enclosed claims.

### BIBLIOGRAPHY

[1] C. A. Vincent and B. Scrosati, Modern Batteries (Butterworth-Heinemann, Oxford, 1997).
[2] B. Scrosati, History of lithium batteries, J. Solid State Electrochem. 15, 1623 (2011).
[3] D. Andre, S.-J. Kim, P. Lamp, S. Franz Lux, F. Maglia, O. Paschosa, and B. Stiaszny, Future generations of cathode materials: an automotive industry perspective, J. Mater. Chem. A 3,6709 (2015).
[4] See, for example, https://www.quantumscape.com/wp-content/uploads/2021/02/Data-Launch-Updated-Post-Presentation-20210107-2.pdf
[5] See, for example, D. P. Di Vincenzo, Quantum computation, Science 270, 255 (1995).
[6] See, for example, S. Vinjanampathy and J. Anders, Quantum thermodynamics, Contemporary Physics 57, 545 (2016).
[7] R. Alicki and M. Fannes, Entanglement boost for extractable work from ensembles of quantum batteries, Phys. Rev. E 87, 042123 (2013).
[8] For a recent review on quantum batteries see, for example, F. Campaioli, F. A. Pollock, and S. Vinjanampathy, in Thermodynamics in the Quantum Regime, F. Binder, L. A. Correa, C. Gogolin, J. Anders, and G. Adesso (eds.), p. 207-225, (Springer, 2018).
[9] K. V. Hovhannisyan, M. Perarnau-Llobet, M. Huber, and A. Acin, Entanglement generation is not necessary for optimal work extraction, Phys. Rev. Lett. 111, 240401 (2013).
[10] F. C. Binder, S. Vinjanampathy, K. Modi, and J. Goold, Quantacell: powerful charging of quantum batteries, New J. Phys. 17, 075015 (2015).
[11] F. Campaioli, F. A. Pollock, F. C. Binder, L. Céleri, J. Goold, S. Vinjanampathy, and K. Modi, Enhancing the charging power of quantum batteries, Phys. Rev. Lett. 118, 150601 (2017).
[12] D. Ferraro, M. Campisi, G. M. Andolina, V. Pellegrini, and M. Polini, High-power collective charging of a solid-state quantum battery, Phys. Rev. Lett. 120, 117702 (2018).
[13] G. M. Andolina, D. Farina, A. Mari, V. Pellegrini, V. Giovannetti, and M. Polini, Charger-mediated energy transfer in exactly solvable models for quantum batteries, Phys. Rev. B 98, 205423 (2018).
[14] G. M. Andolina, M. Keck, A. Mari, M. Campisi, V. Giovannetti, and M. Polini, Extractable work, the role of correlations, and asymptotic freedom in quantum batteries, Phys. Rev. Lett. 122, 047702 (2019).
[15] D. Farina, G. M. Andolina, A. Mari, M. Polini, and V. Giovannetti, Charger-mediated energy transfer for quantum batteries: An open-system approach, Phys. Rev. B 99, 035421 (2019).
[16] T. P. Le, J. Levinsen, K. Modi, M. M. Parish, and F. A. Pollock, Spin-chain model of a many-body quantum battery, Phys. Rev. A 97, 022106 (2018).
[17] D. Rossini, G. M. Andolina, and M. Polini, Many-body localized quantum batteries, Phys. Rev. B 100, 115142 (2019).
[18] S. Ghosh, T. Chanda, and A. Sen De, Enhancement in the performance of a quantum battery by ordered and disordered interactions, Phys. Rev. A 101, 032115 (2020).
[19] J. Q. Quach, K. E. McGhee, L. Ganzer, D. M. Rouse, B. W. Lovett, E. M. Gauger, J. Keeling, G. Cerullo, D. G. Lidzey, and T. Virgili, An organic quantum battery, arXiv:2012.06026.
[20] D. Rossini, G. M. Andolina, D. Rosa, M. Carrega, and M. Polini, Quantum advantage in the charging process of Sachdev-Ye-Kitaev batteries, Phys. Rev. Lett. 125, 236402 (2020).
[21] E. Strambini, A. Iorio, O. Durante, R. Citro, C. Sanz-Ferncndez, C. Guarcello, I. V. Tokatly, A. Braggio, M. Rocci, N. Ligato, V. Zannier, L. Sorba, F. Sebastián Bergeret, and F. Giazotto, A Josephson phase battery, Nature Nanotech. 15, 656 (2020).
[22] P. A. M. Dirac, Lectures on Quantum Mechanics (Dover, New York, 1964).
[23] A. Blais, R.-S. Huang, A. Wallraff, S. M. Girvin, and R. J. Schoelkopf, Cavity quantum electrodynamics for superconducting electrical circuits: An architecture for quantum computation, Phys. Rev. A 69, 062320 (2004).
[24] A. Blais, A. L. Grimsmo, S. M. Girvin, and A. Wallraff, Circuit quantum electrodynamics, Rev. Mod. Phys. 93, 025005 (2021).
[25] J. M. Fink, R. Bianchetti, M. Baur, M. Göppl, L. Steffen, S. Filipp, P. J. Leek, A. Blais, and A. Wallraff, Dressed collective qubit states and the Tavis-Cummings model in circuit QED, Phys. Rev. Lett. 103, 083601 (2009).
[26] P. Winkel, K. Borisov, L. Grünhaupt, D. Rieger, M. Spiecker, F. Valenti, A. V. Ustinov, W. Wemsdorfer, and I. M. Pop, Implementation of a transmon qubit using superconducting granular aluminum, Phys. Rev. X 10, 031032 (2020).
[27] L. Grünhaupt, M. Spiecker, D. Gusenkova, N. Maleeva, S. T. Skacel, I. Takmakov, F. Valenti, P. Winkel, H. Rotzinger, A. V. Ustinov, and I. M. Pop, Granular aluminium as a superconducting material for high-impedance quantum circuits, Nat. Materials 18, 816 (2019).
[28] M. Lyatti, M. A. Wolff, I. Gundareva, M. Kruth, S. Ferrari, R. E. Dunin-Borkowski, and C. Schuck, Energy-level quantization and single-photon control of phase slips in YBa2Cu3O7-x nanowires, Nat. Communications 11, 763 (2020).
[29] B. Müller, M. Karrer, F. Limberger, M. Becker, B. Schröppel, C. J. Burkhardt, R. Kleiner, E. Goldobin, and D. Koelle, Josephson Junctions and SQUIDs created by focused helium-ion-beam irradiation of YBa2Cu3O7, Phys. Rev. Applied 11, 044082 (2019).
[30] F. Priolo, T. Gregorkiewicz, M. Galli, and T. F. Krauss, Silicon nanostructures for photonics and photovoltaics, Nat. Nanotechnology 9, 19 (2014).
[31] S. Morozova, M. Alikina, A. Vinogradov, and M. Pagliaro, Silicon quantum dots: synthesis, encapsulation, and application in light-emitting diodes, Front. Chem. 8, 191 (2020).
[32] S. Terada, Y. Xin, and K.-i. Saitow, Cost-effective synthesis of silicon quantum dots, Chem. Mater. 32, 8382 (2020).
[33] L. Petit, H. G. J. Eenink, M. Russ, W. I. L. Lawrie, N. W. Hendrickx, S. G. J. Philips, J. S. Clarke, L. M. K. Vandersypen, and M. Veldhorst, Universal quantum logic in hot silicon qubits, Nature 580, 355 (2020).
[34] A. Stockklauser, P. Scarlino, J. V. Koski, S. Gasparinetti, C. K. Andersen, C. Reichl, W. Wegscheider, T. Ihn, K. Ensslin, and A. Wallraff, Strong coupling cavity QED with gate-defined double quantum dots enabled by a high impedance resonator, Phys. Rev. X 7, 011030 (2017).
[35] J. V. Koski, A. J. Landig, M. Russ, J. C. Abadillo-Uriel, P. Scarlino, B. Kratochwil, C. Reichl, W. Wegscheider, G. Burkard, M. Friesen, S. N. Coppersmith, A. Wallraff, K. Ensslin, and T. Ihn, Strong photon coupling to the quadrupole moment of an electron in a solid-state qubit, Nat. Physics 16, 642 (2020).
[36] L. De Trizio and L. Manna, Forging colloidal nanostructures via cation exchange reactions, Chem. Rev. 116, 10852 (2016).
[37] L. E Bruhat, T. Cubaynes, J. J. Viennot, M. C. Dartiailh, M. M. Desjardins, A. Cottet, and T. Kontos, Circuit QED with a quantum-dot charge qubit dressed by Cooper pairs, Phys. Rev. B 98, 155313 (2018).
[38] T. Cubaynes, M. R. Delbecq, M. C. Dartiailh, R. Assouly, M. M. Desjardins, L. C. Contamin, L. E. Bruhat, Z. Leghtas, F. Mallet, A. Cottet, and T. Kontos, Highly coherent spin states in carbon nanotubes coupled to cavity photons, npj Quantum Information 5, 47 (2019).
[39] Y. Ben, Z. Hao, C. Sun, F. Ren, N. Tan, and Y. Luo, Three-dimensional photonic-crystal cavity with an embedded quantum dot as a nonclassical light emitter, Opt. Express 12, 5146 (2004).
[40] I. Fushman, D. Englund, and J. Vučković, Coupling of PbS quantum dots to photonic crystal cavities at room temperature, Appl. Phys. Lett. 87, 241102 (2005).
[41] F. S. F. Brossard, X. L. Xu, D. A. Williams, M. Hadjipanayi, M. Hugues, M. Hopkinson, X. Wang, and R. A. Taylor, Strongly coupled single quantum dot in a photonic crystal waveguide cavity, Appl. Phys. Lett. 97, 111101 (2010).
[42] J. Vučković, Quantum optics and cavity QED with quantum dots in photonic crystals, in “Quantum Optics and Nanophotonics”, edited by C. Fabre, V. Sandoghdar, N. Treps, and L. F. Cugliandolo (Oxford University Press, Oxford, 2017).
[43] G. Scalari, C. Maissen, D. Turdinkovc, D. Hagenmüller, S. De Liberato, C. Ciuti, C. Reichl, D. Schuh, W. Wegscheider, M. Beck, and J. Faist, Ultrastrong coupling of the cyclotron transition of a 2D electron gas to a THz metamaterial, Science 335, 1323 (2012).
[44] V. M. Muravev, P. A. Gusikhin, I. V. Andreev, and I. V. Kukushkin, Ultrastrong coupling of high-frequency two-dimensional cyclotron plasma mode with a cavity photon, Phys. Rev. B 8, 045307 (2013).
[45] S. Smolka, W. Wuester, F. Haupt, S. Faelt, W. Wegscheider, and A. Imamoglu, Cavity quantum electrodynamics with many-body states of a two-dimensional electron gas, Science 346, 332 (2014).
[46] Q. Zhang, M. Lou, X. Li, J. L. Reno, W. Pan, J. D. Watson, M. J. Manfra, and J. Kono, Collective non-perturbative coupling of 2D electrons with high-quality-factor terahertz cavity photons, Nat. Physics 12, 1005 (2016).
[47] S. Ravets, P. KnOppel, S. Faelt, M. Kroner, W. Wegscheider, and A. Imamoglu, Polaron Ppolaritons in the integer and fractional quantum Hall regimes, Phys. Rev. Lett. 120, 057401 (2018).
[48] G. L. Paravicini-Bagliani, F. Appugliese, E. Richter, F. Valmorra, J. Keller, M. Beck, N. Bartolo, C. Rössler, T. Ihn, K. Ensslin, C. Ciuti, G. Scalari, and J. Faist, Magneto-transport controlled by Landau polariton states, Nat. Physics 15, 186 (2019).
[49] P. Knüppel, S. Ravets, M. Kroner, S. Fält, W. Wegscheider, and A. Imamoglu, Nonlinear optics in the fractional quantum Hall regime, Nature 572, 91 (2019).
[50] S. Sachdev and J. Ye, Gapless spin-fluid ground state in a random quantum Heisenberg magnet, Phys. Rev. Lett. 70, 3339 (1993).
[51] A. Y. Kitaev, Talks at KITP, University of California, Santa Barbara (USA), Entanglement in Strongly Correlated Quantum Matter (2015).
[52] Y. Gu, A. Kitaev, S. Sachdev, and G. Tamopolsky, Notes on the complex Sachdev-Ye-Kitaev model, J. High Energ. Phys. 2020, 157 (2020).
[53] For a recent review see e.g. V. Rosenhaus, An introduction to the SYK model, J. Phys. A: Math. Theor. 52, 323001 (2019).
[54] For a recent review see e.g. M. Franz and M. Rozali, Mimicking black hole event horizons in atomic and solid-state systems, Nat. Reviews Materials 3, 491 (2018).
[55] A. Chen, R. Ilan, F. de Juan, D. I. Pikulin, and M. Franz, Quantum holography in graphene flake with an irregular boundary, Phys. Rev. Lett. 121, 036403 (2018).
[56] M. I. Katsnelson, K. S. Novoselov, and A. K. Geim, Chiral tunnelling and the Klein paradox in graphene, Nat. Physics 2, 620 (2006).
[57] A. Chew, A. Essin, and J. Alicea, Approximating the Sachdev-Ye-Kitaev model with Majorana wires, Phys. Rev. B 96, 121119(R) (2017).
[58] D. I. Pikulin and M. Franz, Black hole on a chip: Proposal for a physical realization of the Sachdev-Ye-Kitaev model in a solid-state system, Phys. Rev. X 7, 031006 (2017).
[59] L. M. K. Vandersypen and I. L. Chuang, NMR techniques for quantum control and computation, Rev. Mod. Phys. 76, 1037 (2005).
[60] J. I. Cirac and P. Zoller, Quantum Computations with Cold Trapped Ions, Phys. Rev. Lett. 74, 4091 (1995).
[61] T. Monz, P. Schindler, J. T. Barreiro, M. Chwalla, D. Nigg, W. A. Coish, M. Harlander, W. Hansel, M. Hennrich, and R. Blatt, 14-Qubit Entanglement: Creation and Coherence, Phys. Rev. Lett. 106, 130506 (2011).
[62] L. Childress, M. G. Dutt, J. Taylor, A. Zibrov, F. Jelezko, J. Wrachtrup, P. Hemmer, and M. Lukin, Coherent dynamics of coupled electron and nuclear spin qubits in diamond, Science 314, 281 (2006).
[63] J. Kelly et al., State preservation by repetitive error detection in a superconducting quantum circuit, Nature 519, 66 (2015).
[64] Y. Nakamura, Y. A. Pashkin, and J. Tsai, Coherent control of macroscopic quantum states in a single-Cooper-pair box, Nature 398, 786 (1999).
[65] Y. Makhlin, G. Sch6n, and A. Shnirman, Quantum-state engineering with Josephson-junction devices, Rev. Mod. Phys. 73, 357 (2001).
[66] R. Hanson, L. P. Kouwenhoven, J. R. Petta, S. Tarucha, and L. M. K. Vandersypen, Spins in few-electron quantum dots, Rev. Mod. Phys. 79, 1217 (2007).
[67] F. A. Zwanenburg, A. S. Dzurak, A. Morello, M. Y. Simmons, L. C. Hollenberg, G. Klimeck, S. Rogge, S. N. Coppersmith, and M. A. Eriksson, Silicon quantum electronics, Rev. Mod. Phys. 85, 961 (2013).
[68] A. Wallraff et al. Nature 431, 162-167 (2004)
[69] J. M. Chow, A. D. Crcoles, J. M. Gambetta, C. Rigetti, B. R. Johnson, J. A. Smolin, J. R. Rozen, G. A. Keefe, M. B. Rothwell, M. B. Ketchen, and et al., Physical Review Letters 107 (2011), 10.1103/phys-revlett.107.080502.
[71] D. C. McKay, S. Filipp, A. Mezzacapo, E. Magesan, J. M. Chow, and J. M. Gambetta, Physical Review Applied 6 (2016), 10.1103/physrevapplied.6.064007.
[72] M. Ganzhom, D. Egger, P. Barkoutsos, P. Ollitrault, G. Salis, N. Moll, M. Roth, A. Fuhrer, P. Mueller, S. Woerner, and et al., Physical Review Applied 11 (2019), 10.1103/physrevapplied.11.044092.
[73] M. Reagor, C. B. Osborn, N. Tezak, A. Staley, G. Prawiroatmodjo, M. Scheer, N. Alidoust, E. A. Sete, N. Didier, M. P. da Silva, and et al., Science Advances 4, eaao3603 (2018).
[74] L. DiCarlo, J. M. Chow, J. M. Gambetta, L. S. Bishop, B. R. Johnson, D. I. Schuster, J. Majer, A. Blais, L. Frunzio, S. M. Girvin, and et al., Nature 460, 240244 (2009).
[75] R. Barends, J. Kelly, A. Megrant, A. Veitia, D. Sank, E. Jeffrey, T. C. White, J. Mutus, A. G. Fowler, B. Campbell, and et al., Nature 508, 500503 (2014).
[76] M. Rol, F. Battistel, F. Malinowski, C. Bultink, B. Tarasinski, R. Vollmer, N. Haider, N. Muthusubramanian, A. Bruno, B. Terhal, and et al., Physical Review Letters 123 (2019), 10.1103/physrevlett.123.120502.
[77] F. Arute, K. Arya, R. Babbush, D. Bacon, J. C. Bardin, R. Barends, R. Biswas, S. Boixo, F. G. S. L. Brandao, D. A. Buell, and et al., Nature 574, 505510 (2019).
[78] Fang, T., Gao, X., Wang, X. and Liu, J., 2021. Design of gate-tunable graphene electro-optical reflectors based on an optical slot-antenna coupled cavity. Journal of Physics: Photonics, 3(4), p. 045003.
[79] Kaplan, A. E., Bassi, P. and Bellanca, G., 2020. Tunable narrow band optical reflector based on indirectly coupled micro ring resonators. Optics Express, 28(9), pp. 13497-13515.

1. A quantum battery, comprising:
one or more clusters configured to store energy, a first cluster of the one or more clusters comprising:
at least one quantum cell comprising one or more quantum energy units, wherein a first quantum energy unit of the one or more quantum energy units comprises a quantum system having a plurality of energy levels (|ϵ₀ [symbol] _{A}_{_{j,k}}, |ϵ₁ [symbol] _{A}_{_{j,k}}, . . . , |ϵ_{d-1} [symbol] _{A}_{_{j,k}}) configured to store energy.

2. The quantum battery of claim 1, wherein the first quantum energy unit comprises a QUBIT that is a two-energy level quantum system, a QUTRIT that is a three-energy level quantum system, or a QUDIT that is a quantum system with a discrete number of energy levels.

3. The quantum battery of claim 1, wherein the one or more quantum energy units comprise a plurality of quantum energy units and the at least one quantum cell comprises:
an inner quantum bus, operable for causing mutual interactions between quantum energy units of the plurality of quantum energy units,
wherein the inner quantum bus comprises a quantum mechanical system, and
wherein each quantum energy unit is configured to couple with the inner quantum bus under resonant conditions.

4. The quantum battery of claim 3, wherein a first quantum cell of the at least one quantum cell comprises a first control line adjustable by an external control and configured to adjust a charging process of the first quantum cell.

5. The quantum battery of claim 4, wherein the inner quantum bus has a discrete energy spectrum comprising a finite collection of frequencies {ω_{B}}, wherein the finite collection of frequencies {ω_{B}} is configured to be modified by the first control line.

6. The quantum battery of claim 5, wherein:
a resonant condition occurs when the first control line causes a frequency of the finite collection of frequencies {ω_{B}} to be resonant with a level spacing of an energy spectrum of a first quantum energy unit of the plurality of quantum energy units, causing an energy exchange between the inner quantum bus and corresponding quantum energy units within the first quantum cell, and
energy flow from the quantum battery is inhibited by setting the finite collection of frequencies {ω_{B}} to be off-resonant with respect to the energy spectrum of the first quantum energy unit.

7. The quantum battery of claim 4, further comprising:
one or more outer quantum buses,
wherein an outer quantum bus of the one or more outer quantum buses is connected to at least one of the one or more clusters to couple quantum cells of the one or more clusters,
wherein the outer quantum bus is configured to connect to at least one external power source to charge the one or more quantum energy units, and/or to at least one load, to be supplied by energy stored in the one or more quantum energy units after charging, and
wherein the outer quantum bus is configured to charge and discharge the one or more quantum energy units.

8. The quantum battery of claim 7, wherein the outer quantum bus is configured to connect to the at least one external power source and/or to the at least one load through electrodes.

9. The quantum battery of claim 7, wherein the outer quantum bus has a continuous energy spectrum.

10. The quantum battery of claim 7, wherein the outer quantum bus is a waveguide, and wherein propagating electromagnetic modes of the waveguide connect quantum cells of the at least one quantum cell.

11. The quantum battery of claim 7, further comprising a second control line configured to control the outer quantum bus using voltage and/or magnetic pulses to tune interactions between the outer quantum bus and the inner quantum bus.

12. The quantum battery of claim 7, wherein
the first quantum energy unit is a quantum dot, and
the first quantum cell is an electromagnetic cavity.

13. The quantum battery of claim 12, wherein:
the electromagnetic cavity is a Fabry-Pérot resonator,
the inner quantum bus is operated by modes of a quantized cavity electromagnetic field of the electromagnetic cavity, and
the outer quantum bus is operated by electromagnetic modes propagating in wave guides connecting quantum cells of the at least one quantum cell.

14. The quantum battery of claim 1, wherein:
the at least one quantum cell comprises a plurality of quantum cells, and
the one or more quantum energy units comprises a plurality of quantum energy units.

15. The quantum battery of claim 14, wherein the one or more clusters are arranged in a network comprising one of a linear network, a snake-like network, or a three-dimensional network comprising a stack of two-dimensional interconnected quantum cells of the plurality of quantum cells.

16. The quantum battery of claim 15, wherein the one or more clusters have a planar square geometry.

17. The quantum battery of claim 3, wherein
the first quantum energy unit comprises a fully tunable artificial metallic macro-atom having a ground state (|g [symbol] ) and at least one excited state (|e [symbol] ),
the at least one quantum cell comprises a discrete set of fully tunable artificial metallic macro-atoms, and
the inner quantum bus comprises an electromagnetic cavity or resonator in which the at least one quantum cell is disposed and in which a quantized microwave radiation field is disposed.

18. The quantum battery of claim 17, wherein the first quantum energy unit is a transmon-type superconducting QUBIT embedded in a coplanar waveguide resonator.

19. The quantum battery (1) of claim 18, wherein
the transmon-type superconducting QUBIT comprises aluminum and/or yttrium barium copper oxide (YBCO).

20. The quantum battery of claim 17, wherein the fully tunable artificial metallic macro-atom comprises semiconducting materials comprising at least one of: silicon quantum dots, gallium arsenide quantum dots, cadmium selenide (CdSe) quantum dots, and/or carbon nanotube quantum dots.

21. The quantum battery of claim 20, wherein the semiconducting materials comprise semiconducting quantum dots configured to host both charge and spin.

22. A method for charging and discharging a quantum battery, the method comprising:
charging the quantum battery by causing an energy exchange between quantum energy units disposed in at least one quantum cell and having a plurality of energy levels (|ϵ₀ [symbol] _{A}_{_{j,k}}, |ϵ₁ [symbol] _{A}_{_{j,k}}, . . . , |ϵ_{d-1} [symbol] _{A}_{_{j,k}}) and an inner quantum bus having a discrete energy spectrum comprising a finite collection of frequencies ({ω_{B}}) by applying, using a first control line, a resonant excitation between the inner quantum bus and the quantum energy units of the at least one quantum cell to cause a frequency of the finite collection of frequencies ({ω_{B}}) to be in resonance with one of a level-spacing of an energy spectrum of a quantum energy unit of the quantum energy units.

23. The method of claim 22, further comprising:
causing, using a second control line, an energy exchange between at least two clusters of quantum energy units via an outer quantum bus,
wherein the outer quantum bus is configured to connect to at least one external power source configured to charge the quantum energy units, and/or to at least one load, to be supplied by energy stored in the quantum energy units.

24. The method of claim 22, comprising inhibiting energy flow between a quantum energy unit and the inner quantum bus by setting frequencies of the finite collection of frequencies {ω_{B}} to be off-resonant with respect to the energy spectrum of the quantum energy unit.
